(19) United States
(12) Patent Application Publication
(10) Pub. No.: US 2023/0082283 A1
(43) Pub. Date: Mar. 16, 2023

(54) BABY CARRIAGE

(71) Applicant: Wonderland Switzerland AG, Steinhausen (CH)

(72) Inventor: Zhiren Zhong, Steinhausen (CH)

(73) Assignee: Wonderland Switzerland AG, Steinhausen (CH)

(21) Appl. No.: 17/945,108

(22) Filed: Sep. 15, 2022

(30) Foreign Application Priority Data
Sep. 16, 2021 (CN) 202111089505.6
Sep. 30, 2021 (CN) 202111160344.5

(51) Int. Cl. B62B 7/06; B62B 7/08

(52) U.S. Cl. CPC B62B 7/062; B62B 7/064; B62B 7/08

(57) ABSTRACT

A baby carriage includes a handle, a first fixing member, a second fixing member, a rear leg, a front leg, an unlock member, a first lock member, a rotating member and a pulling member. The first lock member engages with the first fixing member and the second fixing member to lock the handle, the rear leg and the front leg at a first unfolded position. When the unlock member pulls the pulling member, the pulling member drives the rotating member to rotate, a first inclined driving surface of the first fixing member pushes the rotating member toward the first lock member, and the rotating member pushes the first lock member toward the second fixing member to disengage the first lock member from the first fixing member.

### BACKGROUND OF THE DISCLOSURE

### 1. Field of the Disclosure

The disclosure relates to a baby carriage and, more particularly, to a baby carriage having a folding mechanism with convenient operation and simple structure.

### 2. Description of the Prior Art

A stroller is a tool used by parents to carry babies or children when they go shopping. At present, there are various foldable strollers to facilitate storage or transportation. However, a folding mechanism of the conventional stroller is not only cumbersome to operate, but also complicated. Thus, it is inconvenient in operation and maintenance and also increases the manufacturing cost of the stroller.

### SUMMARY OF THE DISCLOSURE

The disclosure provides a baby carriage having a folding mechanism with convenient operation and simple structure, so as to solve the aforesaid problems.

According to an embodiment of the disclosure, a baby carriage comprises a handle, a first fixing member, a second fixing member, a rear leg, a front leg, an unlock member, a first lock member, a rotating member and a pulling member. The first fixing member is connected to an end of the handle. The first fixing member has a first inclined driving surface. The second fixing member is pivotally connected to the first fixing member. The rear leg is connected to the second fixing member. The front leg is pivotally connected to the second fixing member. The unlock member is disposed on the handle. The first lock member is disposed between the first fixing member and the second fixing member. The first lock member engages with the first fixing member and the second fixing member to lock the handle, the rear leg and the front leg at a first unfolded position. The rotating member is disposed in the first fixing member and abuts against the first lock member. The pulling member is connected to the unlock member and the rotating member. When the unlock member pulls the pulling member, the pulling member drives the rotating member to rotate, the first inclined driving surface pushes the rotating member toward the first lock member, and the rotating member pushes the first lock member toward the second fixing member to disengage the first lock member from the first fixing member.

Preferably, the baby carriage further comprises a first elastic member abutting against the first fixing member and the rotating member. When the pulling member drives the rotating member to rotate, the rotating member compresses the first elastic member.

Preferably, the first fixing member has a protruding portion, the rotating member has a slot, the protruding portion and the first elastic member are disposed in the slot, an end of the first elastic member abuts against the protruding portion, and another end of the first elastic member abuts against a side wall of the slot.

Preferably, the baby carriage further comprises a second elastic member disposed between the first lock member and the second fixing member. When the rotating member pushes the first lock member toward the second fixing member, the first lock member compresses the second elastic member.

Preferably, the first fixing member has a first engaging recess, the second fixing member has a second engaging recess, the first lock member has a first engaging portion, and the first engaging portion engages with the first engaging recess and the second engaging recess.

Preferably, the first fixing member has an inclined stop surface. When the handle, the rear leg and the front leg are located at a first folded position, the inclined stop surface stops the first lock member. When the handle rotates toward the first unfolded position, the inclined stop surface pushes the first lock member away from the first fixing member.

Preferably, the first fixing member has a first pivot portion, the second fixing member has a second pivot portion, the first lock member has a first through hole, the rotating member has a second through hole, and the first pivot portion and the second pivot portion pass through the first through hole and the second through hole to be pivotally connected to each other.

Preferably, the baby carriage further comprises a bottom tube, a linking member and a basket tube, wherein the bottom tube, the linking member and the basket tube are pivotally connected to each other, the bottom tube is pivotally connected to the front leg, the linking member is pivotally connected to the first fixing member, and the basket tube is pivotally connected to the rear leg.

Preferably, the baby carriage further comprises a seat. The seat comprises a support base, a backrest, a foot rest and a second lock member. The support base is connected to the first fixing member. The backrest is connected to the support base. The foot rest is pivotally connected to the support base. The second lock member is disposed between the support base and the foot rest. The second lock member locks the foot rest at a second unfolded position with respect to the backrest. When the foot rest rotates with respect to the backrest, the foot rest drives the second lock member to unlock.

Preferably, the seat further comprises a third elastic member disposed between the foot rest and the second lock member. When the foot rest drives the second lock member to unlock, the second lock member compresses the third elastic member.

Preferably, the support base comprises a third pivot portion, the foot rest comprises a fourth pivot portion, and the third pivot portion is inserted into the fourth pivot portion, such that the foot rest is pivotally connected to the support base.

Preferably, the foot rest comprise an accommodating recess, the second lock member is movably disposed in the accommodating recess. The second lock member is configured to rotate with the foot rest.

Preferably, the support base comprises a second inclined driving surface. When the foot rest rotates with respect to the backrest from the second unfolded position, the second inclined driving surface pushes the second lock member to move toward the foot rest, so as to drive the second lock member to unlock.

Preferably, the support base further comprises a stop portion located at an end of the second inclined driving surface, and the stop portion stops the second lock member, such that the foot rest is kept at the second unfolded position.

Preferably, the seat further comprises an armbar pivotally connected to the foot rest, the foot rest comprises a guiding groove, the armbar comprises a guiding pillar, and the guiding pillar is inserted into the guiding groove. When the foot rest is folded or unfolded with respect to the backrest, an end portion of the guiding groove pushes the guiding pillar to drive the armbar to be folded or unfolded with respect to the backrest.

Preferably, the armbar is detachably connected to the foot rest.

According to an embodiment of the disclosure, a baby carriage comprises a handle, a first fixing member, a second fixing member, a rear leg, a front leg, a bottom tube, a linking member and a basket tube. The first fixing member is connected to an end of the handle. The second fixing member is pivotally connected to the first fixing member. The rear leg is connected to the second fixing member. The front leg is pivotally connected to the second fixing member. The bottom tube is pivotally connected to the front leg. The linking member is pivotally connected to the first fixing member. The basket tube is pivotally connected to the rear leg. The bottom tube, the linking member and the basket tube are pivotally connected to each other. When the handle rotates to fold or unfold the baby carriage, the handle drives the rear leg, the front leg, the bottom tube, the linking member and the basket tube to pivot to be folded or unfolded.

Preferably, the baby carriage further comprises a seat. The seat comprises a support base, a backrest, a foot rest and a second lock member. The support base is connected to the first fixing member. The backrest is connected to the support base. The foot rest is pivotally connected to the support base. The second lock member is disposed between the support base and the foot rest. The second lock member locks the foot rest at a second unfolded position with respect to the backrest. When the foot rest rotates with respect to the backrest, the foot rest drives the second lock member to unlock.

Preferably, the seat further comprises a third elastic member disposed between the foot rest and the second lock member. When the foot rest drives the second lock member to unlock, the second lock member compresses the third elastic member.

Preferably, the support base comprises a third pivot portion, the foot rest comprises a fourth pivot portion, and the third pivot portion is inserted into the fourth pivot portion, such that the foot rest is pivotally connected to the support base.

Preferably, the foot rest comprise an accommodating recess, the second lock member is movably disposed in the accommodating recess. The second lock member is configured to rotate with the foot rest.

Preferably, the support base comprises a second inclined driving surface. When the foot rest rotates with respect to the backrest from the second unfolded position, the second inclined driving surface pushes the second lock member to move toward the foot rest, so as to drive the second lock member to unlock.

Preferably, the support base further comprises a stop portion located at an end of the second inclined driving surface, and the stop portion stops the second lock member, such that the foot rest is kept at the second unfolded position.

Preferably, the seat further comprises an armbar pivotally connected to the foot rest, the foot rest comprises a guiding groove, the armbar comprises a guiding pillar, and the guiding pillar is inserted into the guiding groove. When the foot rest is folded or unfolded with respect to the backrest, an end portion of the guiding groove pushes the guiding pillar to drive the armbar to be folded or unfolded with respect to the backrest.

Preferably, the armbar is detachably connected to the foot rest.

As mentioned in the above, as long as a user pulls the unlock member, the pulling member will drive the rotating member to rotate to push the first lock member toward the second fixing member, so as to disengage the first lock member from the first fixing member. At this time, the handle, the rear leg and the front leg are able to rotate with respect to each other to be folded. The disclosure utilizes the unlock member, the first lock member, the rotating member and the pulling member to form a folding mechanism of the baby carriage, which not only has a simple structure, but also is convenient to operate, thereby further reducing the manufacturing cost of the baby carriage. Furthermore, as long as the user rotates the foot rest, the seat will be folded or unfolded accordingly. By means of the cooperation between the second lock member and the second inclined driving surface of the support base, the seat of the disclosure may be rapidly folded by rotating the foot rest, which not only has a simple structure, but also is convenient to operate. Since the seat of the disclosure does not need to be equipped with an individual folding mechanism, the manufacturing cost of the seat and the baby carriage may be further reduced.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a side view illustrating a baby carriage according to an embodiment of the disclosure.

FIG. 2 is a side view illustrating a seat shown in FIG. 1 being folded.

FIG. 3 is a side view illustrating the baby carriage shown in FIG. 2 being folded.

FIG. 4 is a perspective view illustrating the baby carriage shown in FIG. 2 without the seat.

FIG. 5 is a perspective view illustrating the baby carriage shown in FIG. 4 during the folding process.

FIG. 6 is a sectional view illustrating a handle and an unlock member.

FIG. 7 is an assembly view illustrating a first fixing member, a rotating member and a first elastic member.

FIG. 8 is an exploded view illustrating a second fixing member and a first lock member.

FIG. 9 is a perspective view illustrating the first fixing member.

FIG. 10 is a perspective view illustrating the second fixing member.

FIG. 11 is a perspective view illustrating an inclined stop surface of the first fixing member stopping the first lock member.

FIG. 12 is a perspective view illustrating a baby carriage according to another embodiment of the disclosure.

FIG. 13 is a perspective view illustrating a seat shown in FIG. 12.

FIG. 14 is a perspective view illustrating the seat shown in FIG. 13 being folded.

FIG. 15 is an exploded view illustrating a foot rest and a support base shown in FIG. 13.

FIG. 16 is an assembly view illustrating the foot rest and a second lock member shown in FIG. 15.

FIG. 17 is a perspective view illustrating a second inclined driving surface of the support base pushing the second lock member.

FIG. 18 is a sectional view illustrating the second lock member located at a locked position.

FIG. 19 is a sectional view illustrating the second lock member located at an unlocked position.

FIG. 20 is a perspective view illustrating the foot rest and an armbar shown in FIG. 13 from another viewing angle.

FIG. 21 is an exploded view illustrating the foot rest and the armbar shown in FIG. 20.

### DETAILED DESCRIPTION

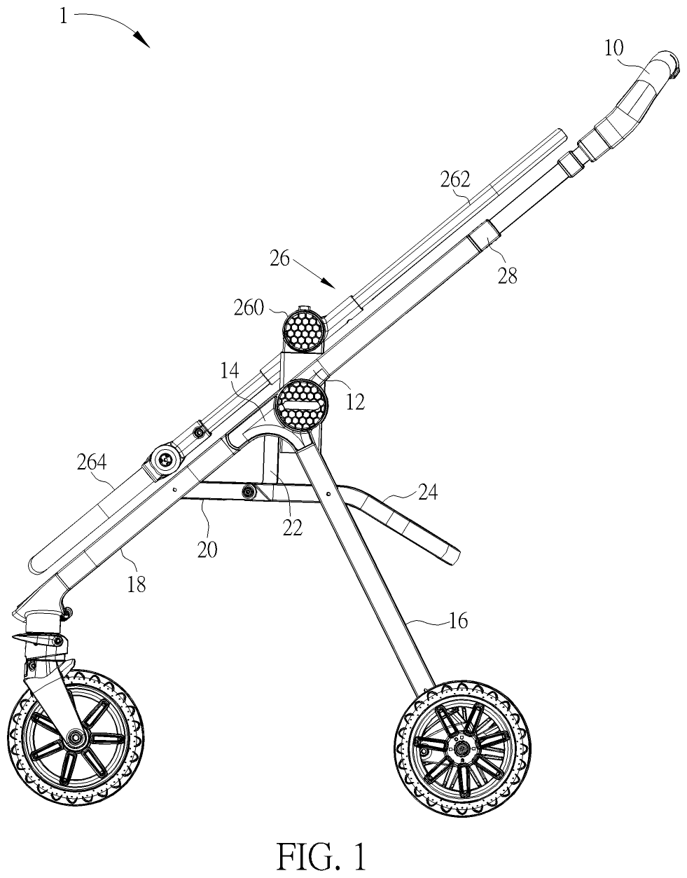

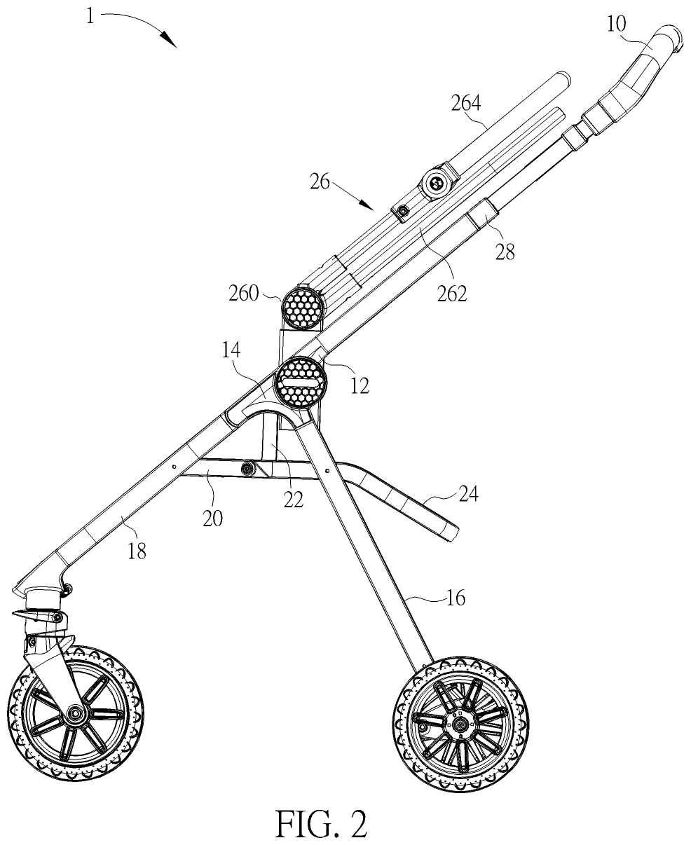

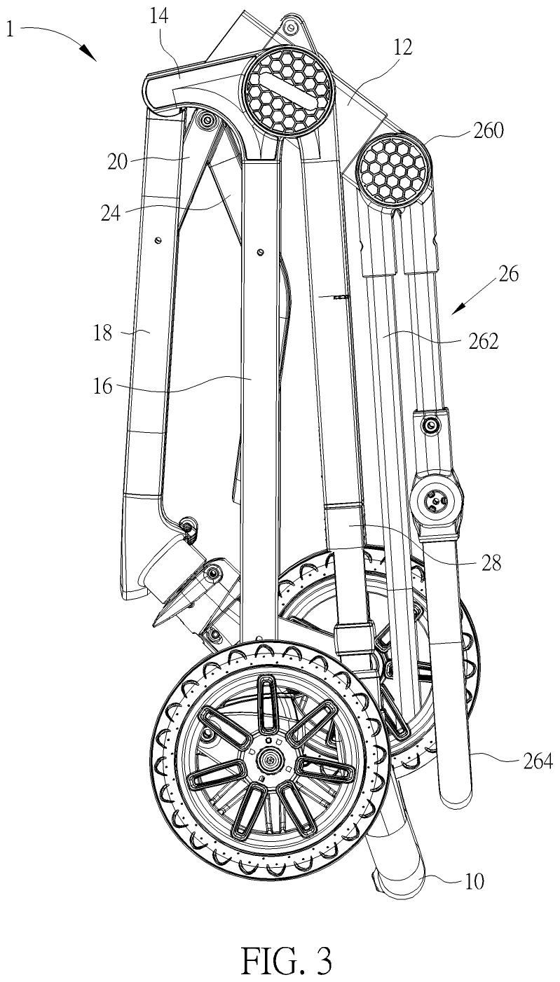

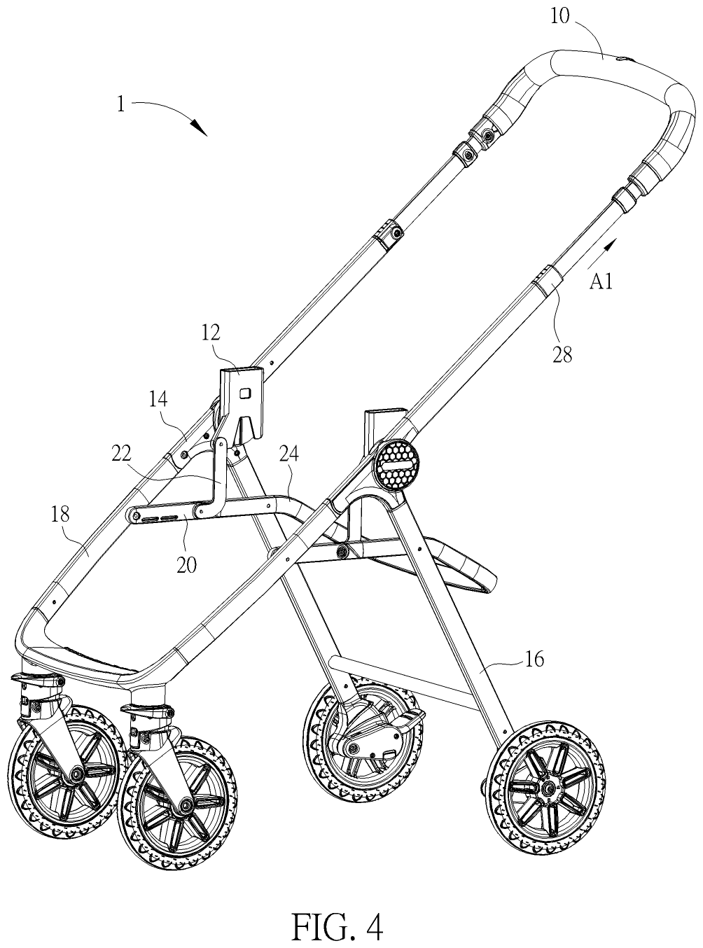

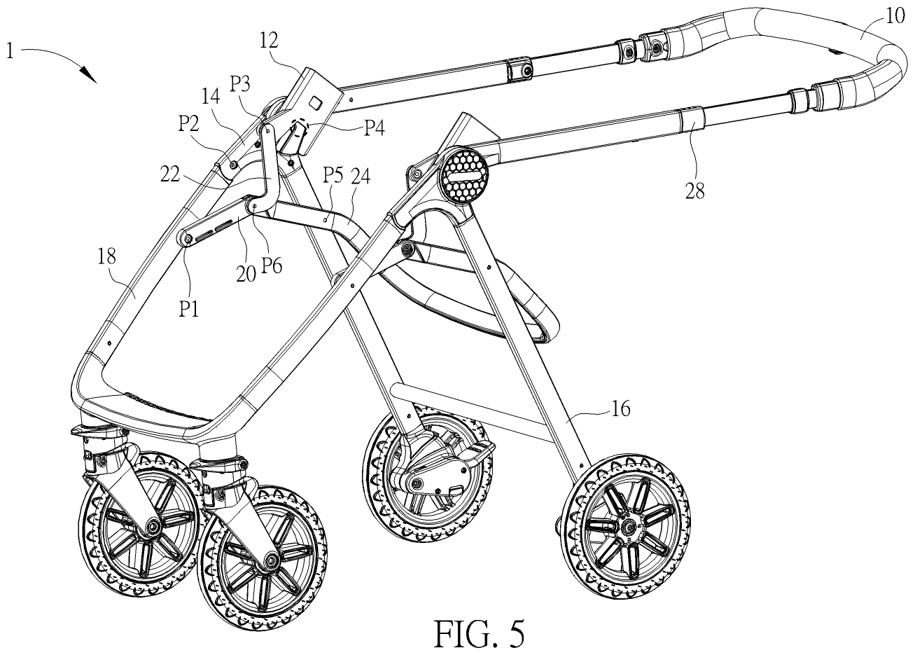

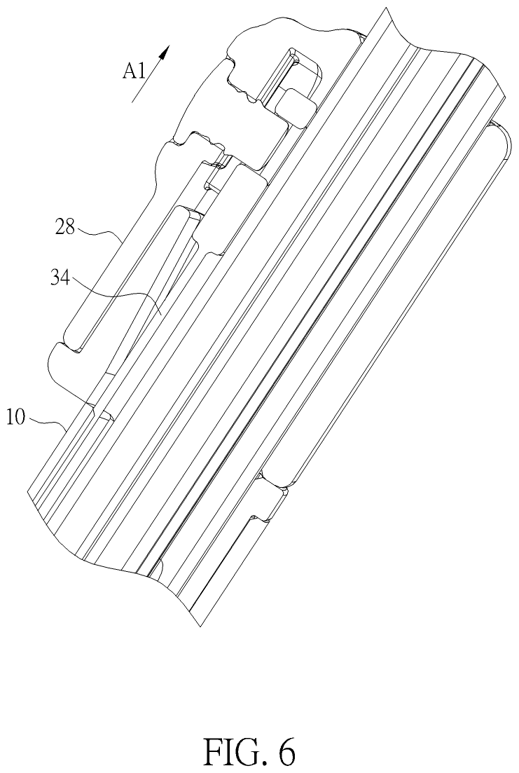

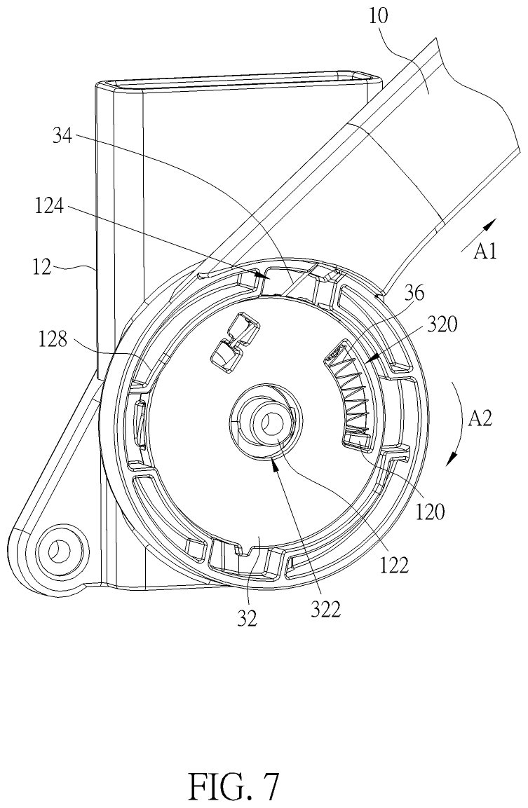

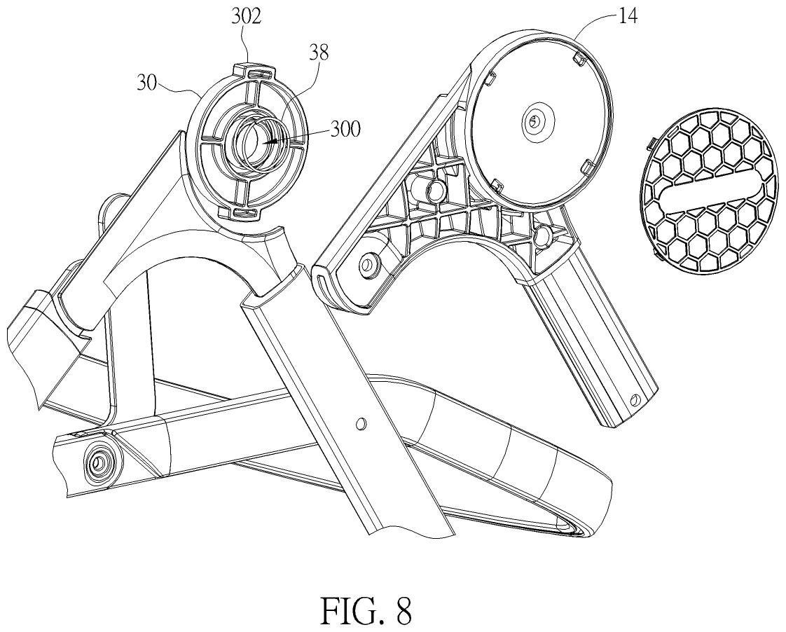

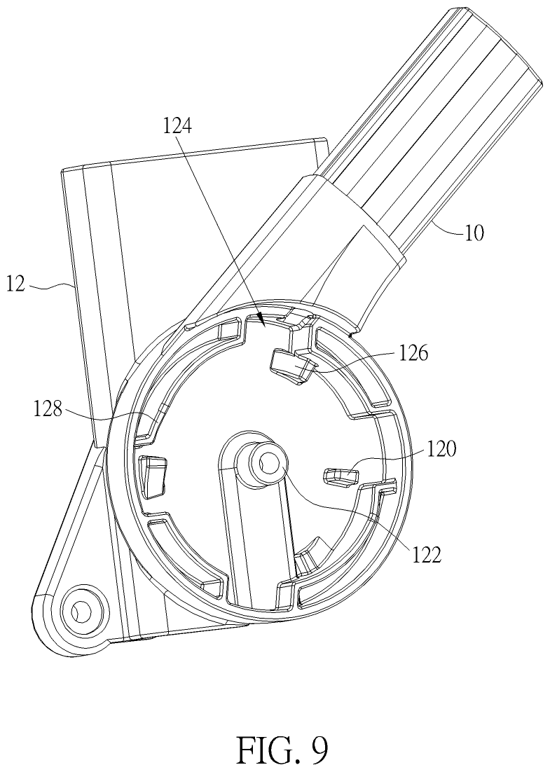

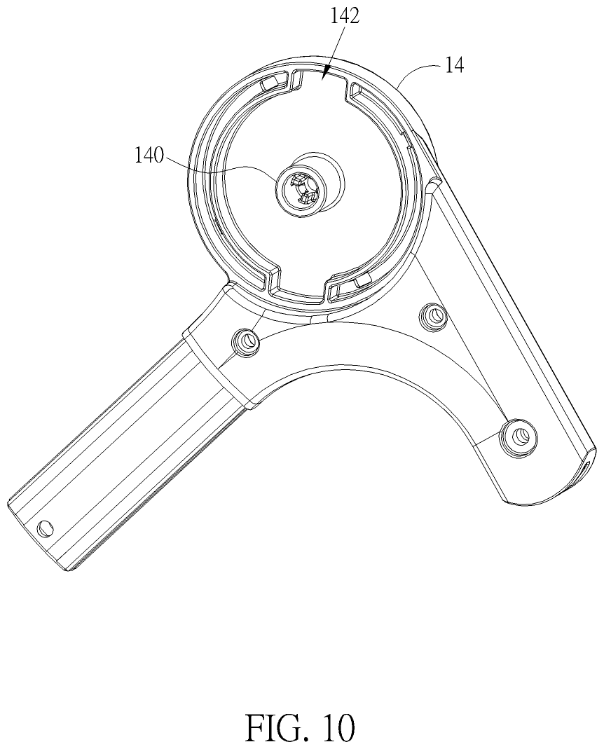

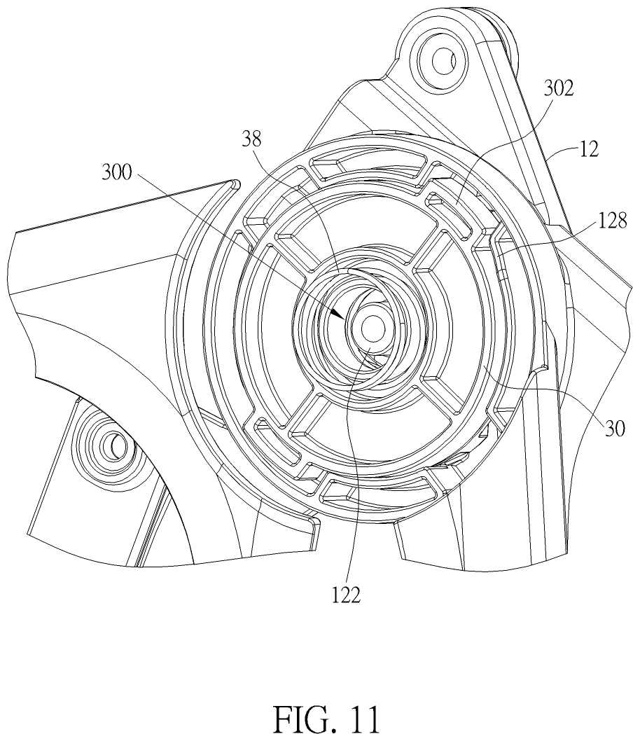

Referring to FIGS. 1 to 11, FIG. 1 is a side view illustrating a baby carriage 1 according to an embodiment of the disclosure, FIG. 2 is a side view illustrating a seat 26 shown in FIG. 1 being folded, FIG. 3 is a side view illustrating the baby carriage 1 shown in FIG. 2 being folded, FIG. 4 is a perspective view illustrating the baby carriage 1 shown in FIG. 2 without the seat 26, FIG. 5 is a perspective view illustrating the baby carriage 1 shown in FIG. 4 during the folding process, FIG. 6 is a sectional view illustrating a handle 10 and an unlock member 28, FIG. 7 is an assembly view illustrating a first fixing member 12, a rotating member 32 and a first elastic member 36, FIG. 8 is an exploded view illustrating a second fixing member 14 and a first lock member 30, FIG. 9 is a perspective view illustrating the first fixing member 12, FIG. 10 is a perspective view illustrating the second fixing member 14, and FIG. 11 is a perspective view illustrating an inclined stop surface 128 of the first fixing member 12 stopping the first lock member 30.

As shown in FIGS. 1 to 5, the baby carriage 1 of the disclosure comprises a handle 10, a first fixing member 12, a second fixing member 14, a rear leg 16, a front leg 18, a bottom tube 20, a linking member 22, a basket tube 24 and a seat 26. The baby carriage 1 may be a stroller or other devices used for carrying babies or objects. It should be noted that the structure of the baby carriage 1 of the disclosure is substantially symmetrical relating to two sides and the technical features of the disclosure will be described by the structure of one of the two sides in the following.

As shown in FIGS. 1 to 5, the first fixing member 12 is connected to an end of the handle 10, the second fixing member 14 is pivotally connected to the first fixing member 12, the rear leg 16 is connected to the second fixing member 14, and the front leg 18 is pivotally connected to the second fixing member 14. The bottom tube 20, the linking member 22 and the basket tube 24 are pivotally connected to one another. The bottom tube 20 is pivotally connected to the front leg 18, the linking member 22 is pivotally connected to the first fixing member 12, and the basket tube 24 is pivotally connected to the rear leg 16. In this embodiment, the linking member 22 may be an L-shaped structure. As shown in FIG. 5, there is a first pivot point P1 between the bottom tube 20 and the front leg 18, there is a second pivot point P2 between the front leg 18 and the second fixing member 14, there is a third pivot point P3 between the linking member 22 and the first fixing member 12, there is a fourth pivot point P4 between the second fixing member 14 and the handle 10, there is a fifth pivot point P5 between the basket tube 24 and the rear leg 16, and there is a sixth pivot point P6 between the bottom tube 20, the linking member 22 and the basket tube 24. When a user wants to fold or unfold the baby carriage 1, the user may rotate the handle 10. When the handle 10 rotates to fold or unfold the baby carriage 1, the handle 10 drives the rear leg 16, the front leg 18, the bottom tube 20, the linking member 22 and the basket tube 24 to pivot with respect to the first to sixth pivot points P1-P6 to be folded or unfolded.

As shown in FIGS. 1 and 2, the seat 26 is installed on the first fixing member 12. In this embodiment, the seat 26 may comprise a support base 260, a backrest 262 and a foot rest 264. The support base 260 is connected to the first fixing member 12. Preferably, the support base 260 is detachably connected to the first fixing member 12, such that the seat 26 may be detached from the baby carriage 1. The backrest 262 is connected to the support base 260 and the foot rest 264 is pivotally connected to the support base 260. Thus, the foot rest 264 is able to rotate with respect to the backrest 262 to be folded or unfolded. When folding the baby carriage 1, the user may rotate the foot rest 264 with respect to the backrest 262 to have the seat 26 be folded first, as shown in FIG. 2. Then, the user rotates the handle 10 downward to drive the rear leg 16, the front leg 18, the bottom tube 20, the linking member 22 and the basket tube 24 to rotate with respect to each other to a first folded position shown in FIG. 3. In this embodiment, the backrest 262 and the foot rest 264 may be, but are not limited to, U-shaped tubes. In practical applications, the backrest 262 and the foot rest 264 may be covered by a fabric to form a seat area for seating. In another embodiment, the seat 26 may be further equipped with other support or reinforced structures (e.g. seat plate) according to practical applications. It should be noted that the structure of the seat 26 maybe determined according to practical applications, so the disclosure is not limited to the embodiment shown in the figures.

As shown in FIGS. 6 to 8, the baby carriage 1 of the disclosure further comprises an unlock member 28, a first lock member 30, a rotating member 32, a pulling member 34, a first elastic member 36 and a second elastic member 38. The unlock member 28 is movably disposed on the handle 10, such that the user may pull the unlock member 28 to move with respect to the handle 10. In this embodiment, there is a pair of unlock members 28 arranged on opposite sides of the handle 10, but the disclosure is not limited thereto. In other embodiments, there may be one single unlock member 28 arranged on an upper end of the handle 10.

As shown in FIGS. 6 to 8, the first lock member 30 is disposed between the first fixing member 12 and the second fixing member 14. The rotating member 32 is disposed in the first fixing member 12 and abuts against the first lock member 30. The pulling member 34 is disposed in the handle 10 and connected to the unlock member 28 and the rotating member 32. The first elastic member 36 abuts against the first fixing member 12 and the rotating member 32. As shown in FIG. 7, in this embodiment, the first fixing member 12 may have a protruding portion 120 and the rotating member 32 may have a slot 320. The protruding portion 120 of the first fixing member 12 and the first elastic member 36 are disposed in the slot 320 of the rotating member 32, wherein an end of the first elastic member 36 abuts against the protruding portion 120 of the first fixing member 12 and another end of the first elastic member 36 abuts against a side wall of the slot 320 of the rotating member 32. As shown in FIG. 8, the second elastic member 38 is disposed between the first lock member 30 and the second fixing member 14. In this embodiment, the pulling member 34 may be, but is not limited to, a steel wire, and the first elastic member 36 and the second elastic member 38 may be, but are not limited to, springs.

As shown in FIGS. 7 to 10, the first fixing member 12 may have a first pivot portion 122, the second fixing member 14 may have a second pivot portion 140, the first lock member 30 may have a first through hole 300, and the rotating member 32 may have a second through hole 322. When assembling the first fixing member 12, the second fixing member 14, the first lock member 30 and the rotating member 32, the first pivot portion 122 of the first fixing member 12 and the second pivot portion 140 of the second fixing member 14 pass through the first through hole 300 of the first lock member 30 and the second through hole 322 of the rotating member 32 to be pivotally connected to each other, so as to form the fourth pivot point P4 shown in FIG. 5.

In this embodiment, the first lock member 30 is configured to engage with the first fixing member 12 and the second fixing member 14 to lock the handle 10, the rear leg 16 and the front leg 18 at a first unfolded position shown in FIGS. 1, 2 and 4. As shown in FIGS. 8 to 10, the first fixing member 12 may have a first engaging recess 124, the second fixing member 14 may have a second engaging recess 142, and the first lock member 30 may have a first engaging portion 302. When the handle 10, the rear leg 16 and the front leg 18 are at the first unfolded position shown in FIGS. 1, 2 and 4, the first engaging recess 124 of the first fixing member 12 is aligned with the second engaging recess 142 of the second fixing member 14, and the first engaging portion 302 of the first lock member 30 engages with the first engaging recess 124 of the first fixing member 12 and the second engaging recess 142 of the second fixing member 14, so as to lock the handle 10, the rear leg 16 and the front leg 18 at the first unfolded position.

As shown in FIG. 4, when a user wants to fold the baby carriage 1, the user may pull the unlock member 28 along a direction represented as an arrow A1. At this time, as shown in FIG. 6, the unlock member 28 pulls the pulling member 34 along the direction of the arrow A1. As shown in FIGS. 6 and 7, when the unlock member 28 pulls the pulling member 34 along the direction of the arrow A1, the pulling member 34 drives the rotating member 32 to rotate along a direction represented as an arrow A2. In this embodiment, the first fixing member 12 has a first inclined driving surface 126, as shown in FIG. 9. Thus, when the pulling member 34 drives the rotating member 32 to rotate along the direction of the arrow A2, the first inclined driving surface 126 of the first fixing member 12 pushes the rotating member 32 toward the first lock member 30 (as shown in FIG. 8) and the rotating member 32 compresses the first elastic member 36. At this time, the rotating member 32 pushes the first lock member 30 toward the second fixing member 14 to disengage the first engaging portion 302 of the first lock member 30 from the first engaging recess 124 of the first fixing member 12, such that the handle 10, the rear leg 16 and the front leg 18 are able to rotate with respect to each other to the first folded position shown in FIG. 3. Furthermore, when the rotating member 32 pushes the first lock member 30 toward the second fixing member 14, the first lock member 30 compresses the second elastic member 38. When the unlock member 28 is released, the first elastic member 36 drives the rotating member 32 to return.

As shown in FIG. 11, the first fixing member 12 may have an inclined stop surface 128. When the handle 10, the rear leg 16 and the front leg 18 are located at the first folded position shown in FIG. 3, the inclined stop surface 128 stops the first lock member 30 to restrain the first lock member 30 from rotating. When the user wants to unfold the baby carriage 1, the user may rotate the handle 10 toward the first unfolded position shown in FIG. 2. When the handle 10 rotates toward the first unfolded position, the inclined stop surface 128 of the first fixing member 12 pushes the first lock member 30 away from the first fixing member 12. When the handle 10, the rear leg 16 and the front leg 18 rotate with respect to each other from the first folded position shown in FIG. 3 to the first unfolded position shown in FIG. 2, the second elastic member 38 drives the first lock member 30 to return, so as to lock the handle 10, the rear leg 16 and the front leg 18 at the first unfolded position.

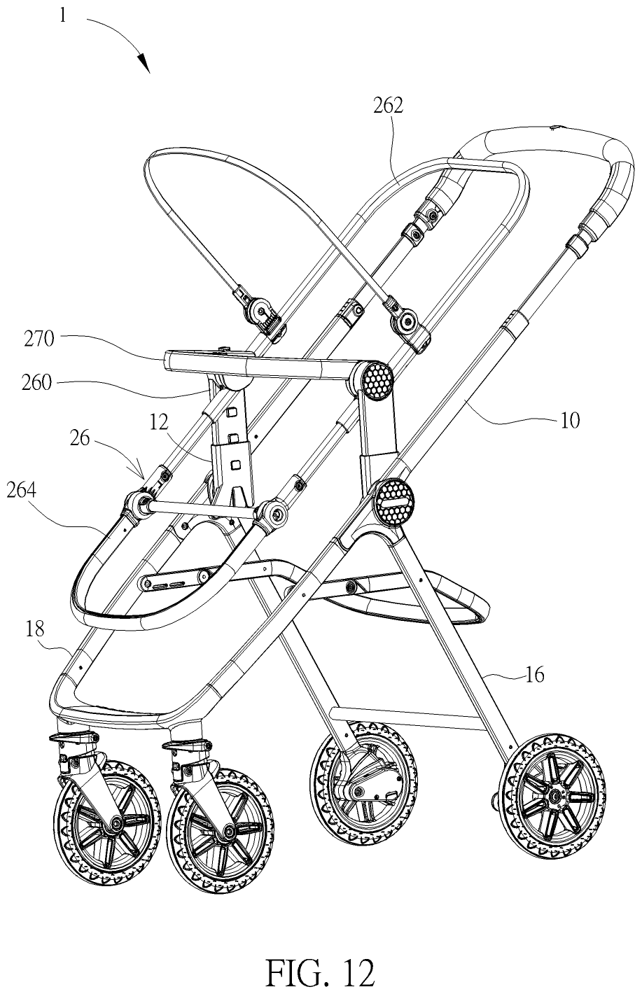

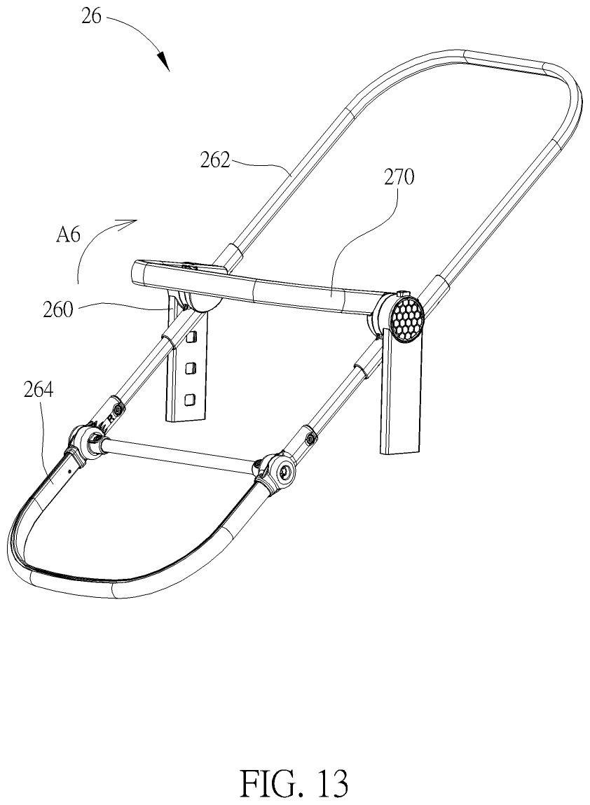

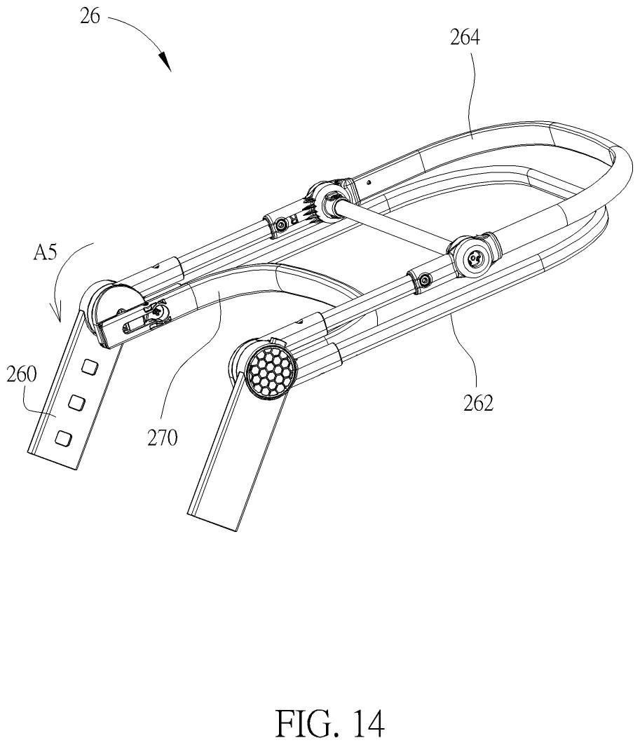

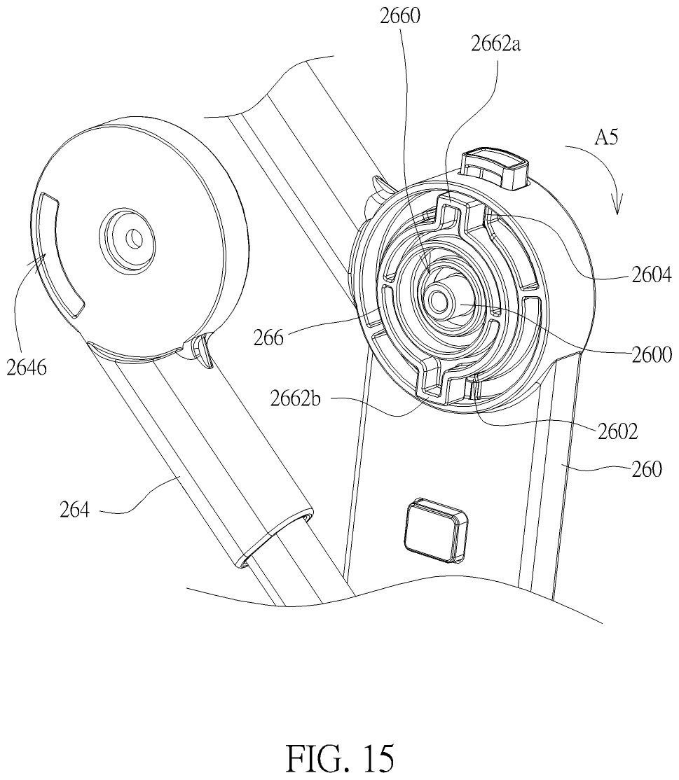

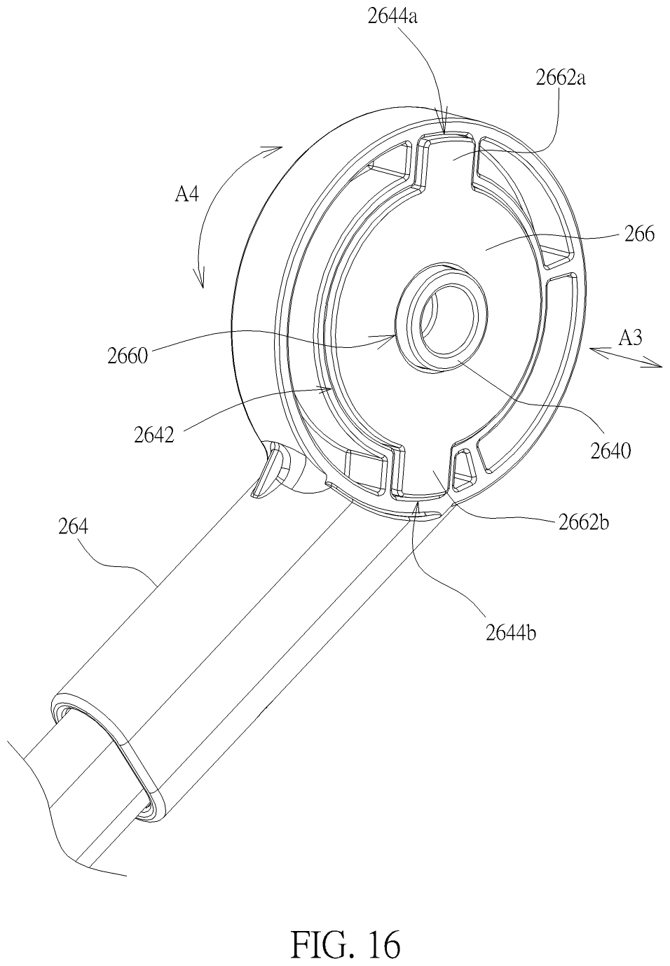

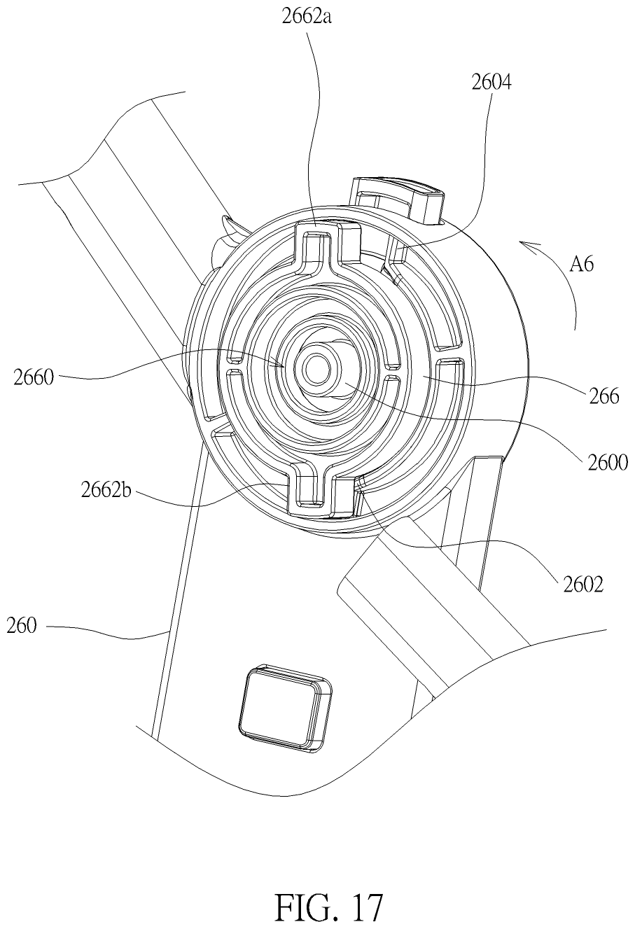

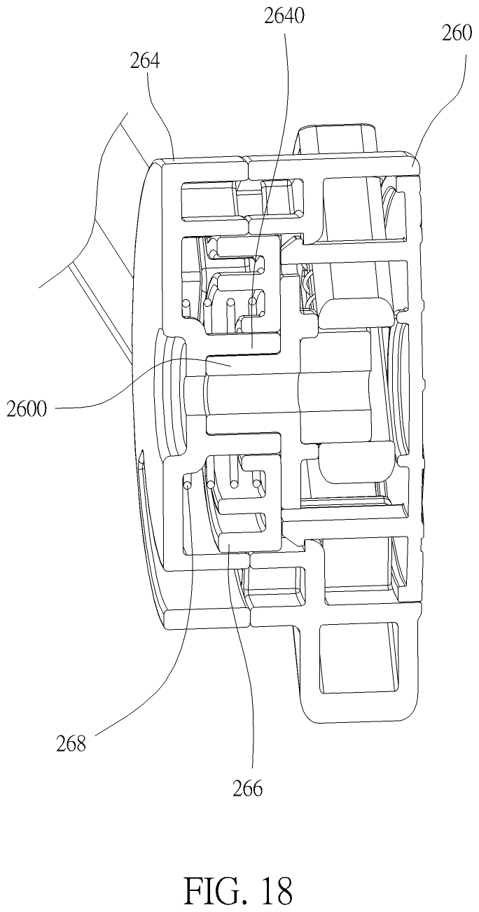

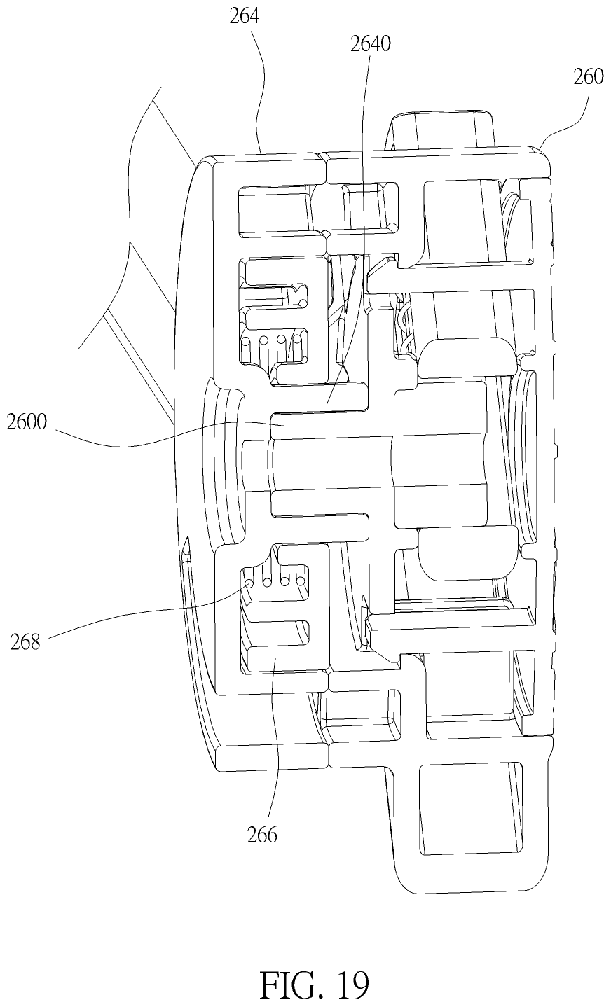

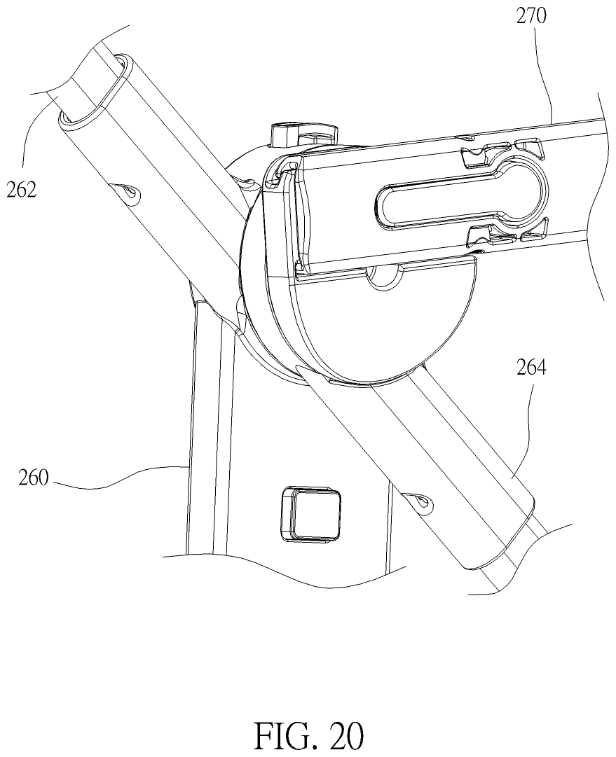

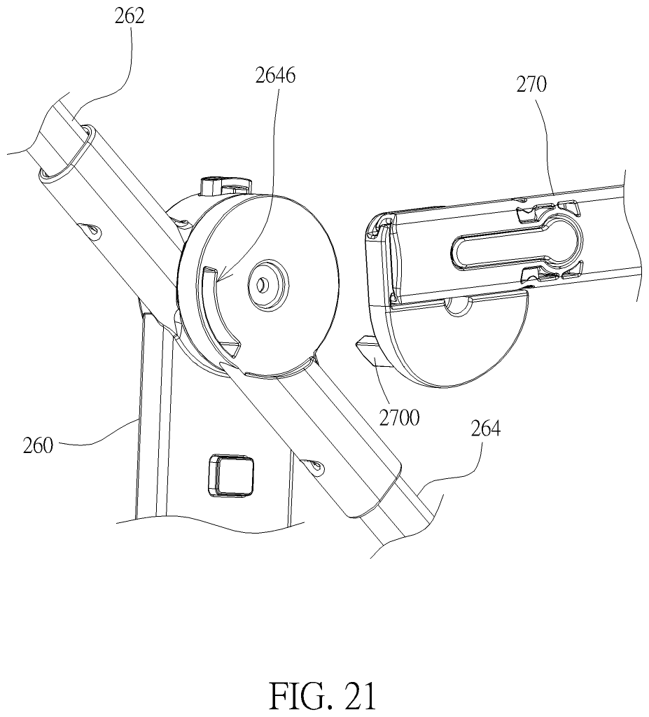

Referring to FIGS. 12 to 21, FIG. 12 is a perspective view illustrating a baby carriage 1 according to another embodiment of the disclosure, FIG. 13 is a perspective view illustrating a seat 26 shown in FIG. 12, FIG. 14 is a perspective view illustrating the seat 26 shown in FIG. 13 being folded, FIG. 15 is an exploded view illustrating a foot rest 264 and a support base 260 shown in FIG. 13, FIG. 16 is an assembly view illustrating the foot rest 264 and a second lock member 266 shown in FIG. 15, FIG. 17 is a perspective view illustrating a second inclined driving surface 2602 of the support base 260 pushing the second lock member 266, FIG. 18 is a sectional view illustrating the second lock member 266 located at a locked position, FIG. 19 is a sectional view illustrating the second lock member 266 located at an unlocked position, FIG. 20 is a perspective view illustrating the foot rest 264 and an armbar 270 shown in FIG. 13 from another viewing angle, and FIG. 21 is an exploded view illustrating the foot rest 264 and the armbar 270 shown in FIG. 20.

As shown in FIGS. 12 and 13, the seat 26 is unfolded. As shown in FIG. 14, the seat 26 is folded. The baby carriage 1 may be folded or unfolded with the seat 26 installed thereon. In another embodiment, the seat 26 may be detachably disposed on the baby carriage 1; the seat 26 may be detached from the baby carriage 1 and then be folded or unfolded individually. It should be noted that the structures of the baby carriage 1 and the seat 26 of the disclosure are substantially symmetrical relating to two sides and the technical features of the disclosure will be described by the structure of one of the two sides in the following.

As shown in FIGS. 12 to 16, the seat 26 comprises a support base 260, a backrest 262, a foot rest 264 and a second lock member 266. The support base 260 is connected to the first fixing member 12 to dispose the seat 26 on the baby carriage 1. The backrest 262 is connected to the support base 260 and the foot rest 264 is pivotally connected to the support base 260. In this embodiment, the backrest 262 and the foot rest 264 may be, but are not limited to, U-shaped tubes. In practical applications, the backrest 262 and the foot rest 264 may be covered by a fabric to form a seat area for seating. In another embodiment, the seat 26 may be further equipped with other support or reinforced structures (e.g. seat plate) according to practical applications.

As shown in FIGS. 15, 16 and 18, the support base 260 comprises a third pivot portion 2600 and the foot rest 264 comprises a fourth pivot portion 2640. The third pivot portion 2600 is inserted into the fourth pivot portion 2640, and the third pivot portion 2600 and the fourth pivot portion 2640 have holes for receiving a pivot (not shown), such that the foot rest 264 is pivotally connected to the support base 260.

As shown in FIGS. 15, 16 and 18, the second lock member 266 is disposed between the support base 260 and the foot rest 264. In this embodiment, the foot rest 264 further comprises an accommodating recess 2642 and two third engaging recesses 2644a, 2644b, wherein the two third engaging recesses 2644a, 2644b are located at opposite sides of the accommodating recess 1264, and the fourth pivot portion 2640 is located in the accommodating recess 2642. Furthermore, the second lock member 266 comprises a third through hole 2660 and two second engaging portions 2662a, 2662b, wherein the two second engaging portions 2662a, 2662b are located at opposite sides of the third through hole 2660. As shown in FIG. 16, the fourth pivot portion 2640 of the foot rest 264 is inserted into the third through hole 2660 of the second lock member 266, such that the second lock member 266 is movably disposed in the accommodating recess 2642 of the foot rest 264. Accordingly, the second lock member 266 is able to move with respect to the foot rest 264 along a direction represented as a double arrow A3 shown in FIG. 16. Furthermore, the two second engaging portions 2662a, 2662b of the second lock member 266 respectively engage with the two third engaging recesses 2644a, 2644b of the foot rest 264, such that the second lock member 266 is able to rotate with the foot rest 264 along a direction represented as a double arrow A4 shown in FIG. 16. The direction of the double arrow A3 is parallel to the axis of rotation of the second lock member 266.

As shown in FIG. 18, the seat 26 further comprises a third elastic member 268 disposed between the foot rest 264 and the second lock member 266. In this embodiment, the third elastic member 268 may be, but is not limited to, a spring. Still further, as shown in FIGS. 15 and 17, the support base 260 further comprises a second inclined driving surface 2602 and a stop portion 2604, wherein the height of the second inclined driving surface 2602 gradually increases from the second engaging portion 2662b to the second engaging portion 2662b, and the stop portion 2604 is located at an end of the second inclined driving surface 2602 and corresponds to the second engaging portion 2662a.

When the foot rest 264 is unfolded with respect to the backrest 262 to a second unfolded position shown in FIGS. 12 and 13, the second lock member 266 is located at a locked position shown in FIG. 18. At this time, the second lock member 266 locks the foot rest 264 at the second unfolded position with respect to the backrest 262. As shown in FIG. 15, when the second lock member 266 is located at the locked position, the stop portion 2604 of the support base 260 stops the second engaging portion 2662a of the second lock member 266, such that the foot rest 264 cannot keep rotating toward a direction represented as an arrow A5. Accordingly, the foot rest 264 will be kept at the second unfolded position.

When a user wants to fold the seat 26, the user may rotate the foot rest 264 shown in FIG. 13 with respect to the backrest 262 toward a direction represented as an arrow A6. When the foot rest 264 rotates with respect to the backrest 262, the foot rest 264 drives the second lock member 266 to unlock, such that the foot rest 264 is able to rotate to a second folded position shown in FIG. 14 with respect to the backrest 262. For further explanation, when the foot rest 264 rotates from the second unfolded position shown in FIG. 13 with respect to the backrest 262 toward the direction of the arrow A6, shown in FIG. 17, the second lock member 266 rotates with the foot rest 264 toward the direction of the arrow A6. At this time, the second inclined driving surface 2602 of the support base 260 pushes the second engaging portion 2662b of the second lock member 266, such that the second lock member 266 moves toward the foot rest 264 along the direction of the double arrow A3 to drive the second lock member to unlock. Then, the second lock member 266 completely enters the accommodating recess 2642 of the foot rest 264 to be located at an unlocked position shown in FIG. 19, such that the foot rest 264 is able to rotate with respect to the backrest 262 to the second folded position shown in FIG. 14. Accordingly, the seat 26 can be rapidly folded by rotating the foot rest 264, which not only has a simple structure, but also is convenient to operate.

As shown in FIG. 19, when the foot rest 264 rotates to drive the second lock member 266 to unlock, the second lock member 266 moves toward the foot rest 264 to compress the third elastic member 268. When the user wants to unfold the seat 26, the user may rotate the foot rest 264 with respect to the backrest 262 toward the direction of the arrow A5 shown in FIG. 14. When the foot rest 264 rotates from the second folded position shown in FIG. 14 to the second unfolded position shown in FIG. 13 with respect to the backrest 262, an elastic force generated by the third elastic member 268 shown in FIG. 19 drives the second lock member 266 to return toward the support base 260, so as to lock the foot rest 264 at the second unfolded position with respect to the backrest 262.

As shown in FIGS. 12 to 14 and 20, the seat 26 may further comprise an armbar 270 pivotally connected to the foot rest 264. Thus, the armbar 270 may also rotate to be folded or unfolded with respect to the backrest 262. Preferably, the armbar 270 may be detachably and pivotally connected to the foot rest 264, such that the armbar 270 may be detached from the seat 26 when not in use. As shown in FIG. 21, the foot rest 264 may comprise a guiding groove 2646 and the armbar 270 may comprise a guiding pillar 2700. When the armbar 270 is pivotally connected to the foot rest 264, the guiding pillar 2700 is inserted into the guiding groove 2646. Thus, when the foot rest 264 rotates to be folded or unfolded with respect to the backrest 262, an end portion of the guiding groove 2646 of the foot rest 264 pushes the guiding pillar 2700 of the armbar 270 to drive the armbar 270 to be folded or unfolded with respect to the backrest 262.

As mentioned in the above, as long as a user pulls the unlock member, the pulling member will drive the rotating member to rotate to push the first lock member toward the second fixing member, so as to disengage the first lock member from the first fixing member. At this time, the handle, the rear leg and the front leg are able to rotate with respect to each other to be folded. The disclosure utilizes the unlock member, the first lock member, the rotating member and the pulling member to form a folding mechanism of the baby carriage, which not only has a simple structure, but also is convenient to operate, thereby further reducing the manufacturing cost of the baby carriage. Furthermore, as long as the user rotates the foot rest, the seat will be folded or unfolded accordingly. By means of the cooperation between the second lock member and the second inclined driving surface of the support base, the seat of the disclosure may be rapidly folded by rotating the foot rest, which not only has a simple structure, but also is convenient to operate. Moreover, if the seat is equipped with the armbar, the user may synchronously fold or unfold the armbar by rotating the foot rest. Since the seat of the disclosure does not need to be equipped with an individual folding mechanism, the manufacturing cost of the seat and the baby carriage may be further reduced.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A baby carriage comprising:
a handle;
a first fixing member connected to an end of the handle, the first fixing member having a first inclined driving surface;
a second fixing member pivotally connected to the first fixing member;
a rear leg connected to the second fixing member;
a front leg pivotally connected to the second fixing member;
an unlock member disposed on the handle;
a first lock member disposed between the first fixing member and the second fixing member, the first lock member engaging with the first fixing member and the second fixing member to lock the handle, the rear leg and the front leg at a first unfolded position;
a rotating member disposed in the first fixing member and abutting against the first lock member; and
a pulling member connected to the unlock member and the rotating member;
wherein, when the unlock member pulls the pulling member, the pulling member drives the rotating member to rotate, the first inclined driving surface pushes the rotating member toward the first lock member, and the rotating member pushes the first lock member toward the second fixing member to disengage the first lock member from the first fixing member.

2. The baby carriage of claim 1, further comprising a first elastic member abutting against the first fixing member and the rotating member; wherein, when the pulling member drives the rotating member to rotate, the rotating member compresses the first elastic member.

3. The baby carriage of claim 2, wherein the first fixing member has a protruding portion, the rotating member has a slot, the protruding portion and the first elastic member are disposed in the slot, an end of the first elastic member abuts against the protruding portion, and another end of the first elastic member abuts against a side wall of the slot.

4. The baby carriage of claim 1, further comprising a second elastic member disposed between the first lock member and the second fixing member; wherein, when the rotating member pushes the first lock member toward the second fixing member, the first lock member compresses the second elastic member.

5. The baby carriage of claim 1, wherein the first fixing member has a first engaging recess, the second fixing member has a second engaging recess, the first lock member has a first engaging portion, and the first engaging portion engages with the first engaging recess and the second engaging recess.

6. The baby carriage of claim 1, wherein the first fixing member has an inclined stop surface; when the handle, the rear leg and the front leg are located at a first folded position, the inclined stop surface stops the first lock member; when the handle rotates toward the first unfolded position, the inclined stop surface pushes the first lock member away from the first fixing member.

7. The baby carriage of claim 1, wherein the first fixing member has a first pivot portion, the second fixing member has a second pivot portion, the first lock member has a first through hole, the rotating member has a second through hole, and the first pivot portion and the second pivot portion pass through the first through hole and the second through hole to be pivotally connected to each other.

8. The baby carriage of claim 1, further comprising a bottom tube, a linking member and a basket tube, wherein the bottom tube, the linking member and the basket tube are pivotally connected to each other, the bottom tube is pivotally connected to the front leg, the linking member is pivotally connected to the first fixing member, and the basket tube is pivotally connected to the rear leg.

9. The baby carriage of claim 1, further comprising a seat, the seat comprising:
a support base connected to the first fixing member;
a backrest connected to the support base;
a foot rest pivotally connected to the support base; and
a second lock member disposed between the support base and the foot rest, the second lock member locking the foot rest at a second unfolded position with respect to the backrest;
wherein, when the foot rest rotates with respect to the backrest, the foot rest drives the second lock member to unlock.

10. The baby carriage of claim 9, wherein the seat further comprises a third elastic member disposed between the foot rest and the second lock member; when the foot rest drives the second lock member to unlock, the second lock member compresses the third elastic member.

11. The baby carriage of claim 9, wherein the support base comprises a third pivot portion, the foot rest comprises a fourth pivot portion, and the third pivot portion is inserted into the fourth pivot portion, such that the foot rest is pivotally connected to the support base.

12. The baby carriage of claim 9, wherein the foot rest comprise an accommodating recess, the second lock member is movably disposed in the accommodating recess; the second lock member is configured to rotate with the foot rest.

13. The baby carriage of claim 9, wherein the support base comprises a second inclined driving surface; when the foot rest rotates with respect to the backrest from the second unfolded position, the second inclined driving surface pushes the second lock member to move toward the foot rest, so as to drive the second lock member to unlock.

14. The baby carriage of claim 13, wherein the support base further comprises a stop portion located at an end of the second inclined driving surface, and the stop portion stops the second lock member, such that the foot rest is kept at the second unfolded position.

15. The baby carriage of claim 9, wherein the seat further comprises an armbar pivotally connected to the foot rest, the foot rest comprises a guiding groove, the armbar comprises a guiding pillar, and the guiding pillar is inserted into the guiding groove; when the foot rest is folded or unfolded with respect to the backrest, an end portion of the guiding groove pushes the guiding pillar to drive the armbar to be folded or unfolded with respect to the backrest.

16. The baby carriage of claim 15, wherein the armbar is detachably and pivotally connected to the foot rest.

17. A baby carriage comprising:
a handle;
a first fixing member connected to an end of the handle;
a second fixing member pivotally connected to the first fixing member;
a rear leg connected to the second fixing member;
a front leg pivotally connected to the second fixing member;
a bottom tube pivotally connected to the front leg;
a linking member pivotally connected to the first fixing member; and
a basket tube pivotally connected to the rear leg, wherein the bottom tube, the linking member and the basket tube are pivotally connected to one another;
wherein, when the handle rotates to fold or unfold the baby carriage, the handle drives the rear leg, the front leg, the bottom tube, the linking member and the basket tube to pivot to be folded or unfolded.

18. The baby carriage of claim 17, further comprising a seat, the seat comprising:
a support base connected to the first fixing member;
a backrest connected to the support base;
a foot rest pivotally connected to the support base; and
a second lock member disposed between the support base and the foot rest, the second lock member locking the foot rest at a second unfolded position with respect to the backrest;
wherein, when the foot rest rotates with respect to the backrest, the foot rest drives the second lock member to unlock.

19. The baby carriage of claim 18, wherein the seat further comprises a third elastic member disposed between the foot rest and the second lock member; when the foot rest drives the second lock member to unlock, the second lock member compresses the third elastic member.

20. The baby carriage of claim 18, wherein the support base comprises a third pivot portion, the foot rest comprises a fourth pivot portion, and the third pivot portion is inserted into the fourth pivot portion, such that the foot rest is pivotally connected to the support base.

21. The baby carriage of claim 18, wherein the foot rest comprise an accommodating recess, the second lock member is movably disposed in the accommodating recess; the second lock member is configured to rotate with the foot rest.

22. The baby carriage of claim 18, wherein the support base comprises a second inclined driving surface; when the foot rest rotates with respect to the backrest from the second unfolded position, the second inclined driving surface pushes the second lock member to move toward the foot rest, so as to drive the second lock member to unlock.

23. The baby carriage of claim 22, wherein the support base further comprises a stop portion located at an end of the second inclined driving surface, and the stop portion stops the second lock member, such that the foot rest is kept at the second unfolded position.

24. The baby carriage of claim 18, wherein the seat further comprises an armbar pivotally connected to the foot rest, the foot rest comprises a guiding groove, the armbar comprises a guiding pillar, and the guiding pillar is inserted into the guiding groove; when the foot rest is folded or unfolded with respect to the backrest, an end portion of the guiding groove pushes the guiding pillar to drive the armbar to be folded or unfolded with respect to the backrest.

25. The baby carriage of claim 24, wherein the armbar is detachably and pivotally connected to the foot rest.
